(19) United States
(12) Patent Application Publication
(10) Pub. No.: US 2015/0227292 A1
(43) Pub. Date: Aug. 13, 2015

(54) METHOD AND APPARATUS FOR MOVING OBJECT IN MOBILE TERMINAL

(71) Applicant: Samsung Electronics Co., Ltd., Gyeonggi-do (KR)

(72) Inventors: Uison Yoon, Gyeonggi-do (KR); Jijoong Moon, Seoul (KR); Bonghee Park, Gyeonggi-do (KR); Inchoon Yeo, Gyeonggi-do (KR); Changsung Lee, Gyeonggi-do (KR)

(21) Appl. No.: 14/415,536

(22) PCT Filed: Jul. 15, 2013
(86) PCT No.: PCT/KR2013/006299

§ 371 Date: Jan. 16, 2015

(30) Foreign Application Priority Data
Jul. 16, 2012 (KR) 10-2012-0077265

(51) Int. Cl. G06F 3/0484; G06F 3/0488; G06F 3/0481

(52) U.S. Cl. CPC G06F 3/04842; G06F 3/04847; G06F 3/0481; G06F 3/0488

(57) ABSTRACT

A method and apparatus for moving an object from the current position to a target position at a speed varying according to the remained distance to the target position in response to a movement command for moving the object on the display screen of the mobile terminal. The object movement method of a terminal of the present invention includes displaying an object; receiving a movement command for moving the object; and moving the object from a current position to a target position at a speed varying according to a distance to the target position.

### TECHNICAL FIELD

The present invention relates to a method and apparatus for moving an object in a mobile terminal. In particular, the present invention relates to a method and apparatus for moving an object from the current position to a target position at a speed varying according to the remained distance to the target position in response to a movement command for moving the object on the display screen of the mobile terminal.

### BACKGROUND ART

Recently, the mobile terminal is becoming a multi-functional device that supports various supplementary functions such as electronic organizer function, game function, and schedule manager function. With the diversification of functions of the mobile terminal, it becomes more necessary to provide efficient user interface for facilitating the use of the various types of supplementary services.

### DISCLOSURE OF INVENTION

### Technical Problem

Meanwhile, with the popularity of mobile terminals such as smartphone, there are many user requirements for convenient and useful interfaces that have been never introduced before.

There is therefore a need of an interface which rotates or moves the screen or object seamlessly in response to the change in screen orientation of the mobile terminal or the receipt of an object movement command.

### Solution to Problem

The present invention has been conceived to solve the above problem, and it is an object of the present invention to provide a method and apparatus for moving, when an object movement command is received, the object from the current position to a target position with the movement distance per unit time which is set differently.

In more detail, it is an object of the present invention to provide a method and apparatus for moving an object smoothly from the view point of the user by calculating center point between the current position and the target position of the object gradually.

In accordance with an aspect of the present invention, an object movement method of a terminal includes displaying an object; receiving a movement command for moving the object; and moving the object from a current position to a target position at a speed varying according to a remained distance to the target position.

In accordance with another aspect of the present invention, a terminal includes a display unit which displays an object; an input unit which receives movement command for moving the displayed object; and a control unit which controls, in receipt of the movement command, moving the object from a current position to a target position at a speed varying according to a remained distance to the target position.

### Advantageous Effects of Invention

According to the present invention, the user is capable of experiencing smooth movement of the object.

### BRIEF DESCRIPTION OF DRAWINGS

FIG. 1 is a block diagram illustrating the configuration of the mobile terminal 100 according to an embodiment of the present invention;

FIG. 2 is a flowchart illustrating an object movement method according to an embodiment of the present invention;

FIG. 3 is a flowchart illustrating the procedure of calculating the movement direction and entire movement distance in response to the receipt of an object movement command according to an embodiment of the present invention;

FIG. 4 is a diagram illustrating the mechanism of acquiring movement direction and entire movement distance according to an embodiment of the present invention;

FIG. 5 is a flowchart illustrating the procedure of determining object's movement distance per unit time according to an embodiment of the present invention;

FIG. 6 is a diagram illustrating exemplary procedure of calculating movement distance per unit time according to an embodiment of the present invention;

FIG. 7 is a graph illustrating variation of movement distance per unit time in an object movement method according to an embodiment of the present invention;

FIG. 8 is a graph illustrating variation of the distance from the current position to the target position in an object movement method according to an embodiment of the present invention;

FIG. 9 is a graph illustrating variation of the divisor to divide the movement distance for calculating the object's movement distance per unit time in an object movement method according to an embodiment of the present invention;

FIG. 10 is a graph illustrating variation of the current position of the object in unit of unit time in an object movement method according to an embodiment of the present invention;

FIG. 11 is a graph illustrating variation of movement speed of the object according to various embodiments of the present invention;

FIG. 12 is a flowchart illustrating the procedure of determining the current position of the object in the object movement method according to an embodiment of the present invention;

FIG. 13 is a diagram illustrating a procedure of rotating an image on the display panel along with the rotation of the mobile terminal in the object movement method according to an embodiment of the present invention;

FIG. 14 is a diagram illustrating a procedure of moving an icon displayed on the display panel of the mobile terminal in response to a movement command target to the icon in the object movement method according to an embodiment of the present invention; and

FIG. 15 is a diagram illustrating a procedure of switching from a currently displayed image to next image in response to a flip input in the object movement method according to an embodiment of the present invention.

### MODE FOR THE INVENTION

In the following description, the term ‘object’ denotes any of things including image, motion picture, still picture, icon, and button, but not limited to the above enumerated items.

In the following description, the term ‘movement’ denotes any of actions including rotation of an object in accordance with the rotation of the mobile terminal, change of icon in position, and screen shift in response to image flip input, but not limited to the above-enumerated actions.

Exemplary embodiments of the present invention are described with reference to the accompanying drawings in detail. The same reference numbers are used throughout the drawings to refer to the same or like parts. Detailed description of well-known functions and structures incorporated herein may be omitted to avoid obscuring the subject matter of the present invention.

In the following, a description is made of the algorithm for calculating movement position (rotation angle) per unit time to provide the user with natural motion (rotation) when an object displayed on the screen is moved (rotated) in response to a user input. That is, the present invention proposes a method for calculating a position (rotation angle) changing gradually according to a certain environmental parameter with the input of current position (angle) and target position (angle) of the object based on a reference point.

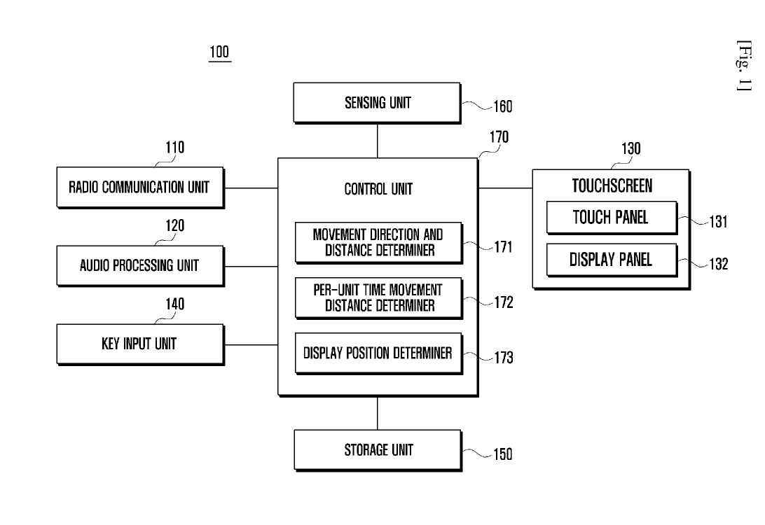

FIG. 1 is a block diagram illustrating the configuration of the mobile terminal 100 according to an embodiment of the present invention. As shown in FIG. 1, the mobile terminal 100 of the present invention includes a radio communication unit 110, an audio processing unit 120, a touchscreen 130, a key input unit 140, a storage unit 150, a sensing unit 160, and a control unit 170.

The RF unit 110 is responsible for transmitting/receiving radio signals carrying data. The RF unit 110 can include an RF transmitter for up-converting and amplifying transmission signal and an RF receiver for low noise amplifying and down-converting the received signal. The RF unit 110 outputs the data received over the radio channel to the control unit 170 and transmits the data output by the control unit 110 over the radio channel.

The audio processing unit 120 can include a codec pack, and the codec pack can include a data codec for processing packet data and an audio codec for processing audio signal including voice. The audio processing unit 120 converts a digital audio signal to an analog audio signal by means of the audio codec to output the audio through a speaker (SPK) and converts the analog audio signal input through a microphone (MIC) to the digital audio signal by means of the audio codec.

The touchscreen unit 130 includes a touch panel 131 and a display panel 132. The touch panel 131 detects a touch input made by the user. The touch sensor can be implemented by one of a capacitive overlay, a resistive overlay, and an infrared beam, or a pressure sensor. The touch panel 131 also can be implemented with other types of sensing devices detecting contact or pressure made by an object. The touch panel 131 detects a touch input made by the user and generates a detection signal to the control unit 170. The detection signal includes the coordinates at which the touch input is detected. In case that the contact of the touch is moved, the touch panel 131 generates the detection signal including the coordinates on the path of the contact to the control unit 170.

The display panel 132 can be implemented with any of Liquid Crystal Display (LCD), Organic Light Emitting Diodes (OLED), and Active Matrix OLED (AMOLED) so as to provide the user with information such as menu of the mobile terminal 100, input data, and function setting information in the form of visual data. The display panel 132 outputs the booting screen, standby mode screen, menu screen, call progress screen, and various application execution screens.

Although the description is directed to the mobile terminal equipped with a touchscreen, the present invention can be applied to the mobile terminals implemented without touchscreen. In case of the mobile terminal having no touchscreen, the touchscreen unit 130 of FIG. 1 can be configured to operate only with the function of the display panel 132.

The key input unit 140 generates a key signal for controlling the mobile terminal 100 to the control unit 170 in response to the user's key manipulation. The key input unit 140 can be implemented with a keypad having numeric keys, navigation keys and functions keys arranged at a side of the mobile terminal. According to an embodiment of the present invention, when the mobile terminal 100 can be fully controlled only with the touchscreen unit 130, the key input unit 140 can be omitted.

The storage unit 150 is responsible for storing programs and data necessary for the operations of the mobile terminal 100 and can be divided into a program region and a data region. The program region stores the programs for controlling the entire operations of the mobile terminal, Operating System (OS) for booting up the mobile terminal 100, application programs related to the playback of multimedia contents and optional functions of the mobile terminal 100 such as camera function, audio playback function, still and motion picture playback function, etc. The data region stores the data generated in association with the operation of the mobile terminal 100 such as still and motion pictures, phonebook, and audio data.

The sensing unit 160 may include any of all the types of sensors capable of acquiring motion, impact, direction, and slop information of the mobile terminal. The sensing unit 160 may include a gyro censor, a motion sensor, a proximity sensor, etc.

The control unit 170 controls overall operations of the components of the mobile terminal. Particularly, when an object movement command is received, the control unit 170 sets the movement distance per unit time differently to move the object from the current position to a target position. In order to accomplish this, the control unit 170 further includes a movement direction and distance determiner 171, a per-unit time movement distance determiner 172, and a display position determiner 173.

If the object movement command is received, the movement direction and distance determiner 171 determines the movement direction and entire movement distance of the object. In more detail, the movement direction and distance determiner 171 sets the movement direction and entire movement distance of the object based on the target position and current position of the object.

In order to determine the movement direction, the movement direction and distance determiner 171 determines a first temporary value according to the sizes of the target position and current position. The movement direction and distance determiner 171 determines the difference value between the target and current positions and a second temporary value according to the size of the middle distance. Next, the movement direction and distance determiner 171 determines the multiplication result of the first and second temporary values. For example, if the multiplication result is a positive number, the object moves in an increasing direction and, otherwise, if the multiplication result is a negative number, the object moves in a decreasing direction.

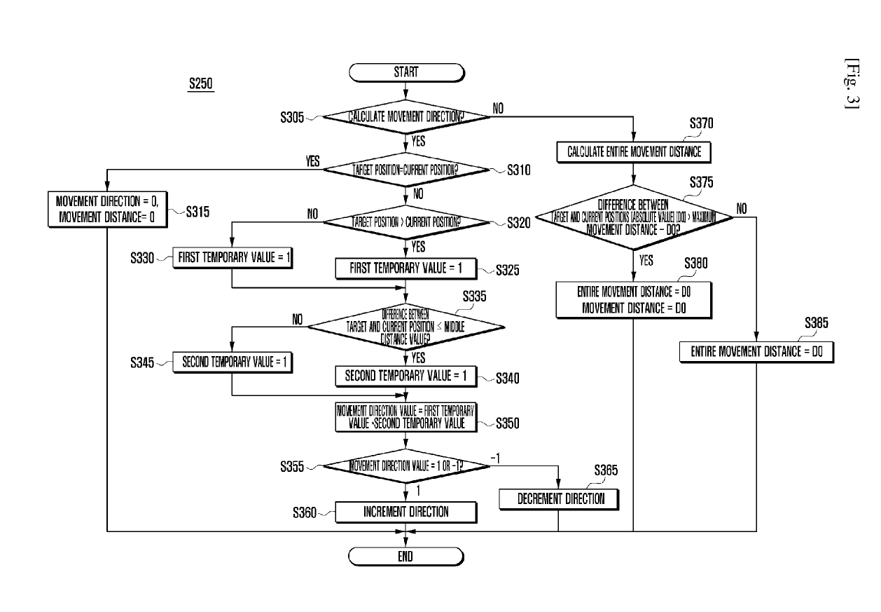

The movement direction and distance determiner 171 calculates a difference value (D0) between the target and current positions. Next, the movement direction and distance determiner 171 determine the entire movement distance of the object according to the size of the difference value acquired by subtracting the distance value between the target and current positions from the maximum distance value (maximum distance value−D0). The entire movement distance determination procedure is described in detail with reference to FIG. 3.

The per-unit time movement distance determiner 172 determines the distance to move per unit time within the entire movement distance. For this purpose, the per-unit time movement distance determiner 172 may set the value obtained by dividing the distance from the current position to the target position of the object with divisor value as the distance per unit time. In this case, the divisor value is a sum of the initial divisor value and increment divisor value, the increment divisor value increases sequentially whenever unit time elapses.

The display position determiner 173 calculates the position where the object is displayed on the screen based on whether the value to which the distance and direction of movement of the object from the current position is exceed the target position without deviating from the range on the screen.

Although the description is directed to the case where the control unit 170, the movement direction and distance determiner 171, the per-unit time movement distance determiner 172, and the display position determiner 173 are formed as separate blocks responsible for distinct functions for the convenience purpose but not limited to that configuration. For example, certain function of the movement direction and distance determiner 171 may be performed by the control unit 170 in itself.

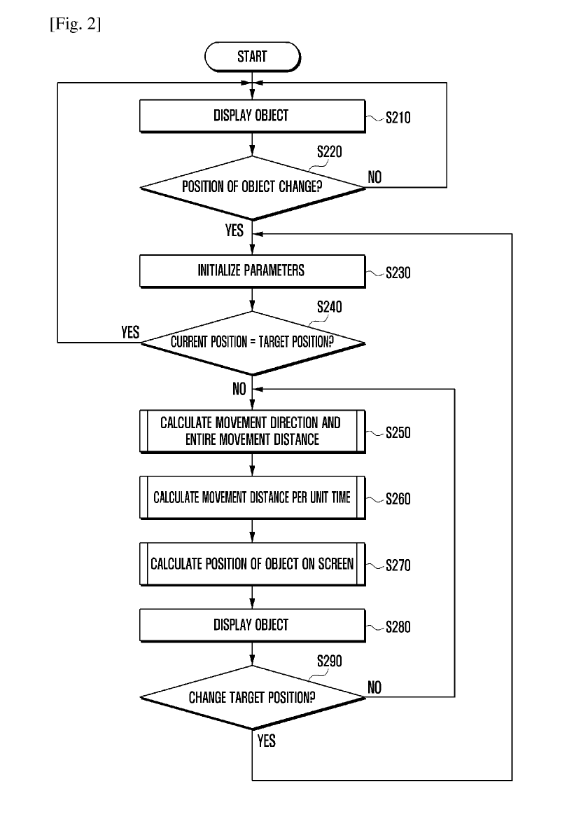

FIG. 2 is a flowchart illustrating an object movement method according to an embodiment of the present invention.

First, the control unit 170 displays an object to be moved on the display panel of the mobile terminal 100 at step S210. The control unit 170 determines whether an object movement command is received at step S220. In this case, the control unit 170 may determine the receipt of the movement command based on whether the position of the object changes. The control unit 170 may also determine the receipt of the movement command based on whether the rotation of the mobile terminal is detected by means of the sensing unit 160.

If it is determined that the position of the object has changed, the control unit 170 initializes the parameters necessary for moving the object by setting the movement distance per unit time differently. The parameters are described later in detail.

Next, the control unit 170 determines whether the current position and the target position match each other at step S240. If the current and target positions match, this means that the object has moved to the target position completely and thus the procedure returns to step S210 because no more movement of the object is necessary.

Otherwise, if the current and target positions mismatch, this means that the object has to move further to reach the target object and thus the control unit 170 calculates the movement direction and distance at step S250.

Then the control unit 170 calculates the movement direction and the entire movement distance of the object at step S250. The procedure of calculating the movement direction and the entire movement distance of the object according to an embodiment of the present invention is described later with reference to FIG. 3.

After calculating the movement direction and entire movement distance, the control unit calculates the movement distance per unit time at step S260. In this case, the control unit 170 may set the movement distance per unit time for the object variable. According to an embodiment of the present invention, this makes it possible to vary the movement speed of the object from the current position to the target position and thus the user feels that the object moves smoothly. Description on the step S260 for calculating the movement distance per unit time is made is made later in more detail with reference to FIG. 5.

The control unit 170 calculates the position where the object is displayed on the screen based on whether the value obtained by applying the movement distance and direction to the current position of the object exceeds the target position in the range on the screen at step S270.

The control unit 170 moves the object according to the movement direction and the movement distance per unit time determined as above at step S280. The control unit 170 determines whether the target position of the object has changed at step S290.

If the target position has not changed, the control unit 170 returns the procedure to step S240 to adjust the movement distance per unit time based on the movement distance per unit time which has been set right before. Otherwise, if the target position has changed, the control unit 170 returns the procedure to step S230 to initialize the movement distance per unit time to the initial reference value.

As described above, the method according to an embodiment of the present invention checks whether the target position has changed even in moving the object and, if the target position has changed, initializes the parameters to calculate the movement direction and distance again. As a consequence, the user feels that the object moves smoothly.

FIG. 3 is a flowchart illustrating the procedure of calculating the movement direction and entire movement distance in response to the receipt of an object movement command according to an embodiment of the present invention. FIG. 3 shows the details of step S250 of FIG. 5.

In FIG. 3, the movement direction or the entire movement distance of the object is calculated. The control unit 170 determines whether to calculate the movement direction of the object at step S305. The procedure is branched to step S310 for calculating the movement direction and step S370 for calculating the movement distance.

First, a description is made of the process of calculating the movement direction of the object. In order to calculate the movement direction of the object, the control unit 170 determines whether the target and current positions match each other at step S310. If the target and current positions match, this means that there is no need of object movement and thus the procedure goes to step S315. The control unit 170 sets both the movement direction and movement distance to 0 and ends the procedure.

Otherwise, if the target and current positions mismatch, the control unit 170 determines whether the target position is greater than the current position at step S320. At this time, the control unit 170 compares the absolute coordinate values of the target position and the absolute coordinate values of the current position. For example, if the target position is upper right as compared to the current position, it is interpreted that the target position is greater than the current position on both the horizontal and vertical axes. For another example, if the target position is lower right as compared to the current position, it is interpreted that the target position is greater than the current position on the horizontal axis but less than the current position on the vertical axis. If the movement is rotation, the control unit may compare the target position and the current position in size of rotation angle. For example, if the current position is at 240 degree to a certain reference position in the clockwise direction and if the current position is at 30 degree to the reference position in the clockwise direction, this is interpreted that the target position is greater than the current position.

If it is determined that the target position is greater than the current position, the control unit 170 sets the first temporary value to 1 (positive integer) at step S325. Otherwise if it is determined that the target position is less than the current position, the control unit sets the first temporary value to −1 (negative integer) at step S330.

The control unit 170 determines the difference value between the target and current positions is equal to or less than a middle distance (MID_DIST) at step S335. If the movement is a rotation movement, the middle distance denotes the half of a 360 degree, i.e. 180 degree. Likewise, if the movement is a linear strain movement, the middle distance may denote the coordinates at the middle between bottom left point and the top right point on the screen. If the difference value is equal to or less than the middle distance value, the control unit 170 sets the second temporary value to 1 (positive integer) at step S340 and, otherwise if the difference value is greater than the middle distance value, the control unit 170 sets the second temporary value to −1 (negative integer).

The control unit 170 multiplies the first and second temporary values to acquire the movement direction value at step S350. Next, the control unit 170 determines whether the calculated movement direction value is 1 (positive integer) or −1 (negative integer) at step S355.

If the movement direction value is 1 (positive integer), the control unit 170 determines that the movement direction of the object is an increment direction at step S360. Otherwise, if the movement direction value is −1 (negative integer), the control unit 170 determines that the movement direction of the object is a decrement direction at step S365.

In this way, the control unit 170 calculates the first and second temporary values and determines the movement direction of the object based on the multiplication result of the two temporary values.

Meanwhile, the control unit 170 determines to calculate the movement distance of the object at step S370. In this case, the control unit 170 calculates the size (D0) of the difference value between the target position and the current position at step S375. Next, the control unit 170 compares the D0 value and the size of difference value (D1) between the maximum distance value (MAX_DIST) and D0. The maximum distance value corresponds to 360 degree for the rotation movement or coordinates values at the top right point on the screen for the linear strait movement.

If D0 is greater than D1, the control unit 170 sets the entire movement distance to D1 at step S380. Otherwise, if D0 is less than D1, the control unit 170 sets the entire movement distance to D0 at step S385.

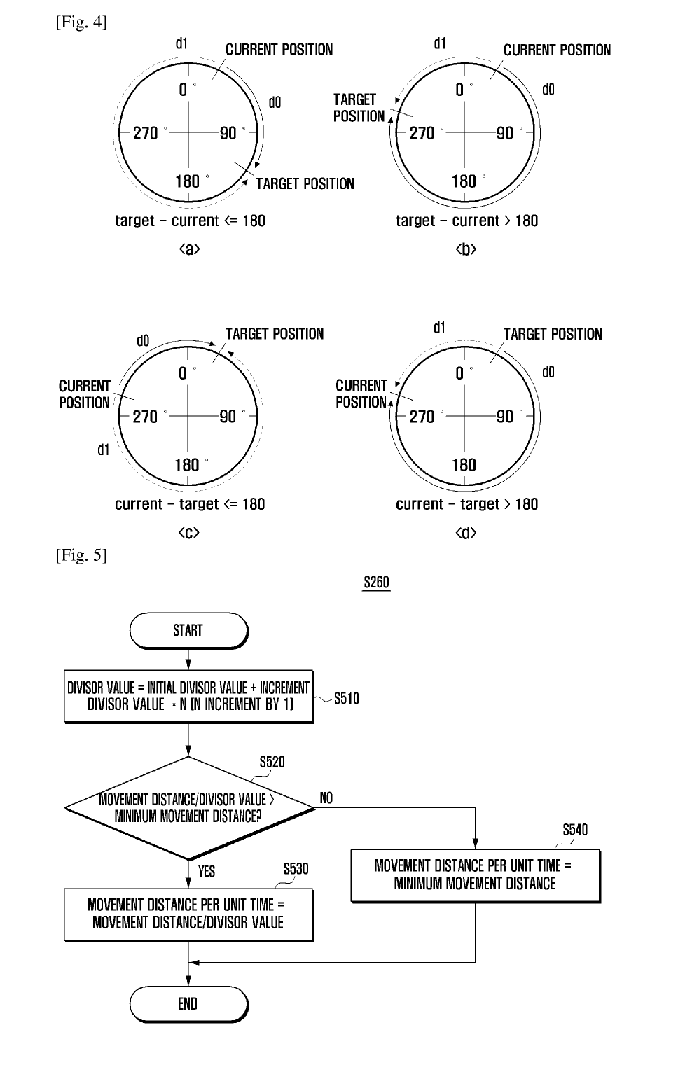

FIG. 4 is a diagram illustrating the mechanism of acquiring movement direction and entire movement distance according to an embodiment of the present invention.

FIG. 4 is directed to the case where the movement of the object is rotation movement. In FIG. 4, the object's movement direction calculation is described with reference to steps S310 to S365 and the object's entire movement distance calculation is described with reference to steps 370 to 385 of FIG. 3.

A description is made of the order of acquiring the movement direction of the object in the exemplary case of part <a> of FIG. 4.

In part <a> of FIG. 4, since the current and target positions mismatch, the control unit 170 compares the current and target position in size. Since the size of the target position is greater than the current position in part <a> of FIG. 4, the control unit 170 sets the first temporary to 1 (positive integer). Next, the control unit 170 compares the difference value between the target and current positions with the middle distance value (180 degree in rotation movement). In FIG. 4a, since the 180 degree as the middle distance value is greater than the different between the target and current positions, the control unit 170 sets the second temporary value to 1 (positive integer). The control unit 170 multiplies the first and second temporary values to check the movement direction value is 1 (positive integer). Since the movement direction value is 1 (positive integer), the control unit 170 sets the rotation direction of the object to clockwise direction.

Hereinafter, a description is made of the order of acquiring the movement distance of the object in the example case of part <a> of FIG. 4.

In part <a> of FIG. 4, the control unit 170 compares the difference value D0 between the target and current positions and the distance value D1 between the maximum distance value and D0 to acquire the entire movement distance of the object. Since D1 is greater than D0 in part <a> of FIG. 4, the entire movement distance of the object is set to D0.

In summary, the control unit 170 configures such that the object moves as much as d0 in the clockwise direction in the exemplary case of part <a> of FIG. 4.

Hereinafter, a description is made of the order of acquiring the movement direction of the object in the exemplary case of part <b> of FIG. 4.

In part <b> of FIG. 4, since the current and target positions mismatch, the control unit 170 compares the current and target positions each other in size. Since the size of the target position is greater than that of the current position in part <b> of FIG. 4, the control unit sets the first temporary value to 1 (positive integer). Next, the control unit 170 compares the difference value between the target and current positions and the middle distance size (180 degree in rotation movement). Since the middle distance value of 180 degree is less than the difference value between the target and current positions in part <a> of FIG. 4, the control unit sets the second temporary value to −1 (negative integer). Next, the control unit 170 multiplies the first and second temporary values to check that the movement direction value is −1 (negative integer). Since the movement direction value is −1 (negative integer), the control unit 170 sets the rotation direction of the object to counterclockwise direction.

A description is made of the order of acquiring movement distance of an object in the exemplary case of part <b> of FIG. 4 hereinafter.

In part <b> of FIG. 4, the control unit 170 compares the difference value D0 between the target and current positions and the difference value D1 between the maximum distance value and D0 to calculate the entire movement distance of the object. Since D0 is greater than D1 in part <b> of FIG. 4, the entire movement distance of the object is set to D1.

In summary, the control unit 170 configures such that the object moves as much as dl in the counterclockwise direction in the exemplary case of part <b> of FIG. 4.

Hereinafter, a description is made of the order of calculating the movement direction of the object tin the exemplary case of part <c> of FIG. 4.

In part <c> of FIG. 4, since the current and target positions of the object mismatch, the control unit 170 compares the current and target positions in size. Since the size of the current position is greater than that of the target position in part <c> of FIG. 4, the control unit 170 sets the first temporary value to −1 (negative integer). Next, the control unit 170 compares the difference value between the target and current positions with the middle distance value in size (180 degree in rotation movement). Since 180 degree as the size of the middle distance value is less than the difference value between the target and current positions in part <c> of FIG. 4, the control unit 170 sets the second temporary value to −1 (negative integer). Next, the control unit 170 multiplies the first and second temporary values to checks that the movement direction value is 1 (positive integer). Since the movement direction value is 1 (positive integer), the control unit 170 sets the rotation direction of the object to the clockwise direction.

Hereinafter, a description is made of the order of calculating the movement distance of the object in part <c> of FIG. 4.

In part <c> of FIG. 4, the control unit 170 compares the difference value D0 between the target and current positions with the difference value D1 between the maximum distance value and D0 to calculate the entire movement distance of the object. Since D0 is greater than D1 in part <c> of FIG. 4, the entire movement distance of the object is set to D0.

In summary, the control unit 170 configures such that the object moves as much as d0 in the clockwise direction in the exemplary case of part <c> of FIG. 4.

Finally, a description is made of the order of acquiring the movement direction of the object in part <d> of FIG. 4.

Since the current and target positions mismatch in part <d> of FIG. 4, the control unit 170 compares the current and target positions in size. Since the size of the target position is greater than that of the current position in part <d> of FIG. 4, the control unit 170 sets the first temporary value to 1 (positive integer). Next, the control unit 170 compares the distance value between the target and current positions with the middle distance value (180 degree in rotation movement). Since 180 degree as the middle distance size is less than the difference value between the target and current positions, the control unit 170 sets the second temporary value to −1 (negative integer). Next, the control unit 170 multiplies the first and second temporary values to check that the movement direction value is −1 (negative integer). Since the movement direction value is −1 (negative integer), the control unit 170 sets the rotation direction of the object to counterclockwise direction.

Hereinafter, a description is made of the order of acquiring movement distance of the object in part <d> of FIG. 4.

The control unit 170 compares the distance value D0 between the target and current positions with the difference value D1 between the maximum distance value and D0 to calculate the entire movement distance of the object. Since D0 is greater than D1 in part <d> of FIG. 4, the control unit 170 sets the entire movement distance to D1.

In summary, the control unit 170 configures such that the object moves as much as dl in the counterclockwise direction.

FIG. 5 is a flowchart illustrating the procedure of determining object's movement distance per unit time according to an embodiment of the present invention. FIG. 5 shows details of step S260 of FIG. 2.

A description is made of the principle of determining the objects' movement distance per unit time according to an embodiment of the present invention. The object's movement distance per unit time is determined by equation (1):

Movement distance per unit time=movement distance (DIST)/divisor (1),

where the movement distance (DIS) denotes the distance from the current position to the target position.

According to a preferred embodiment of the present invention, the movement distance decreases as time advances, and the divisor increases as time goes on. Accordingly, the object's movement distance per unit time decreases gradually. This means that the object moves fast at the time which the movement command is received, and the movement speed of the object decreases gradually as the object is drawn near the target position.

The procedure of determining object's movement distance per unit time is described with reference to FIG. 5 hereinafter.

First, the control unit 170 sets the devisor according to equation 2 at step S510.

Divisor=initial divisor value (DIV_INIT)+increment divisor value (INC_DIV)*n(INTER)(n increment by 1 whenever unit time elapses) (2),

where the divisor denotes a certain parameter dividing the movement distance of the object (distance from the current position to the target position) in the current time duration.

The control unit 170 determines whether the value obtained by dividing the movement distance with the divisor is greater than a predetermined minimum movement distance at step S520. Here, the reason for setting the minimum movement distance is to have the object arrive the target position accurately.

If the value obtained by dividing the movement distance with the divisor is greater than the minimum movement distance, the control unit 170 sets the movement distance per unit time to the movement distance/divisor value according to equation (1) at step S530. Otherwise, if the value obtained by dividing the movement distance with the divisor is less than the minimum movement distance, the control unit 170 sets the movement distance per unit time to the minimum movement distance at step S540.

Although the description is directed to the case where the object's movement speed per unit time decreases as the object is drawn near the target position, it is also possible to implement the present invention in such a way that the movement speed per unit time increases as the object is drawn near the target. In this case, if the increment divisor value is set to a negative value in equation (2), the adviser value decreases whenever the unit time elapses and, as a consequence, the movement distance per unit time increases.

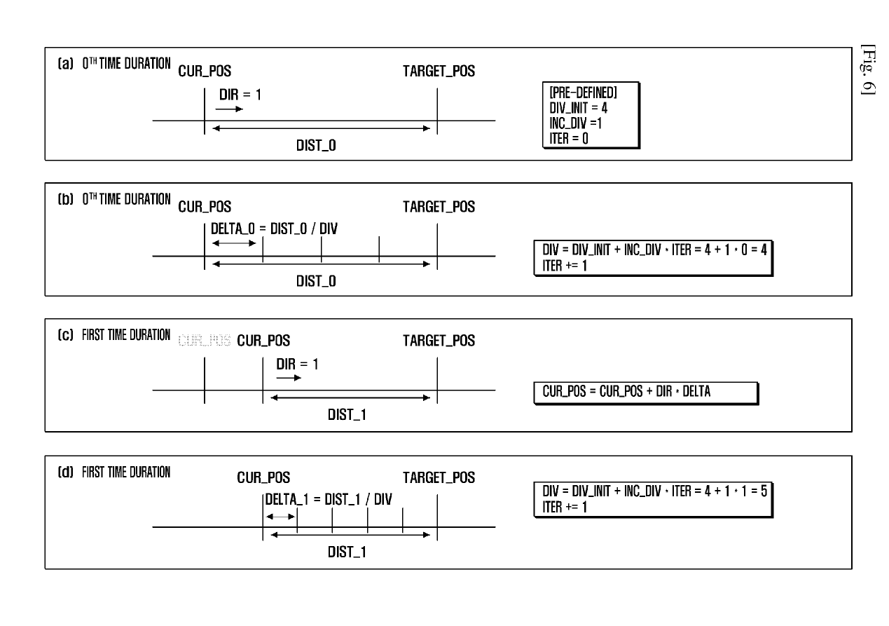

FIG. 6 is a diagram illustrating exemplary procedure of calculating movement distance per unit time according to an embodiment of the present invention.

In part (a) of FIG. 6, the entire movement distance (DIST_{—}0) and movement direction (DIR=1) of the object is determined with a 0th time duration. The initial divisor is set to 4, and the increment divisor value is set to 1.

In part (b) of FIG. 6, the movement distance per unit time is determined in the 0th time duration. The movement distance per unit time is expressed by delta (DELTA_{—}0), and the divisor value for use in dividing the entire movement distance of the object is set to 4. Accordingly, the object moves as much as DELTA_{—}0 as shown in part (b) of FIG. 6. As much as the delta the object has moved, the current position value of the object is changed.

In part (c) of FIG. 6, the time duration changes from the 0th time duration (INTER=0) to the first time duration (INTER=1), and the movement distance (DIST_{—}1) and the movement direction (DIR=1) are determined. The movement distance (DIST_{—}1) of the object in the first time duration is less than the movement distance (DIST_{—}0) in the 0th time duration.

As shown in part (d) of FIG. 6, the movement distance per unit time is indicated by delta (DELTA_{—}1), and the divisor value for use in dividing the entire movement distance of the object is set to 5. Accordingly, in the first time duration, the object moves as much as DELTA_{—}1 shown in part (d) of FIG. 6. Then the current position value changes as much as the distance of delta that the object has moved.

According to an embodiment of the present invention, the operations of parts (c) and (d) of FIG. 6 are repeated until the object arrives at the target position from the current position. In this case, as the time duration increases, the movement distance (DIST) decreases and the divisor value increases such that the object's movement distance per unit time decreases gradually.

Meanwhile, if the target position changes in the state that the object is moving, the time duration may be initialized to INTER=0 in part (a) of FIG. 6.

As described above, it should be noted that when the increment divisor value is negative the movement distance per unit time increases gradually.

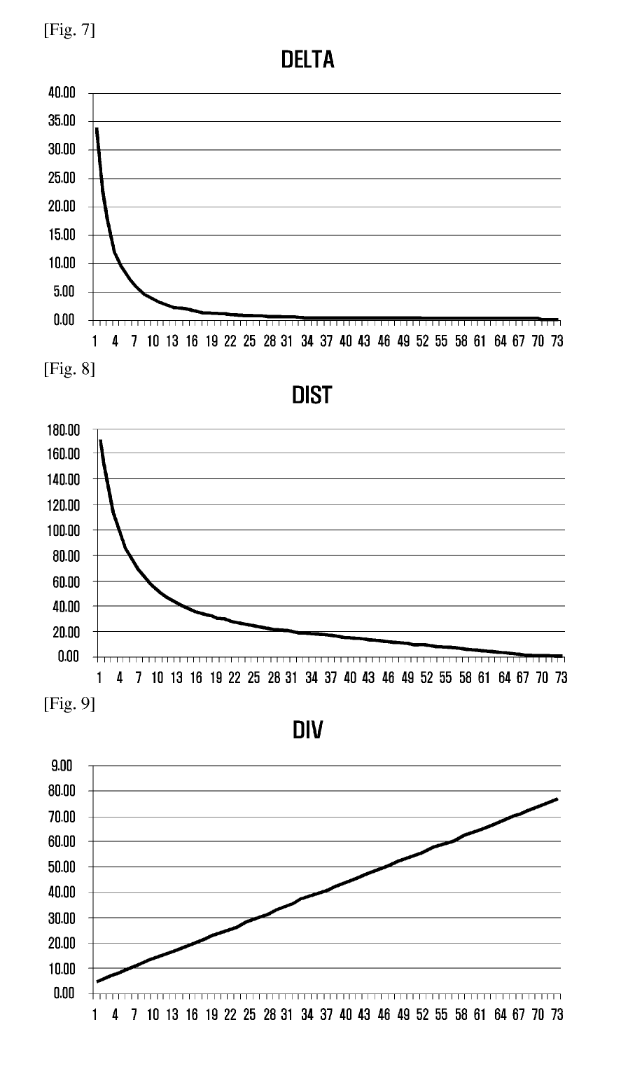

FIGS. 7 to 10 are graphs illustrating variations of output values associated with the movement of the object in the object movement method according to an embodiment of the present invention. The parameters may be predefined as shown in table 1. In this case, the horizontal axis indicates time duration (INTER), and the vertical axis indicates the movement speed of the object.

TABLE 1

CUR_POS(current position) = 10

TARGET_POS(target position) = 180
INIT_DIV(initial divisor value) = 5
DIV_INC(increment divisor value) = 1
MIN_DELTA(minimum movement distance) =

0.5

MIN_DIST(minimum distance value) = 0
MID_DIST(middle distance value) = 180
MAX_DIST(maximum distance value) = 360

FIG. 7 is a graph illustrating variation of movement distance per unit time.

The object's movement distance per unit time id indicated by DELTA in FIG. 7. Since the increment divisor value is set to 1 (positive integer) as shown table 1, the divisor value increases as time advances. Accordingly, the movement distance per unit time decreases as time advances.

FIG. 8 is a graph illustrating variation of the distance from the current position to the target position.

The distance (movement distance) from the current position to the target position is indicated by DIST. As shown in equation (1), the movement distance is in proportion to the movement distance per unit time, the curve is similar to that of FIG. 7.

FIG. 9 is a graph illustrating variation of the divisor to divide the movement distance for calculating the object's movement distance per unit time.

The divisor value is proportion to the increment divisor value (INC_DIV). Since it is assumed that the increment divisor value is 1 (positive value) in table 1, the divisor value forms a straight line having the slope of 1 in the graph.

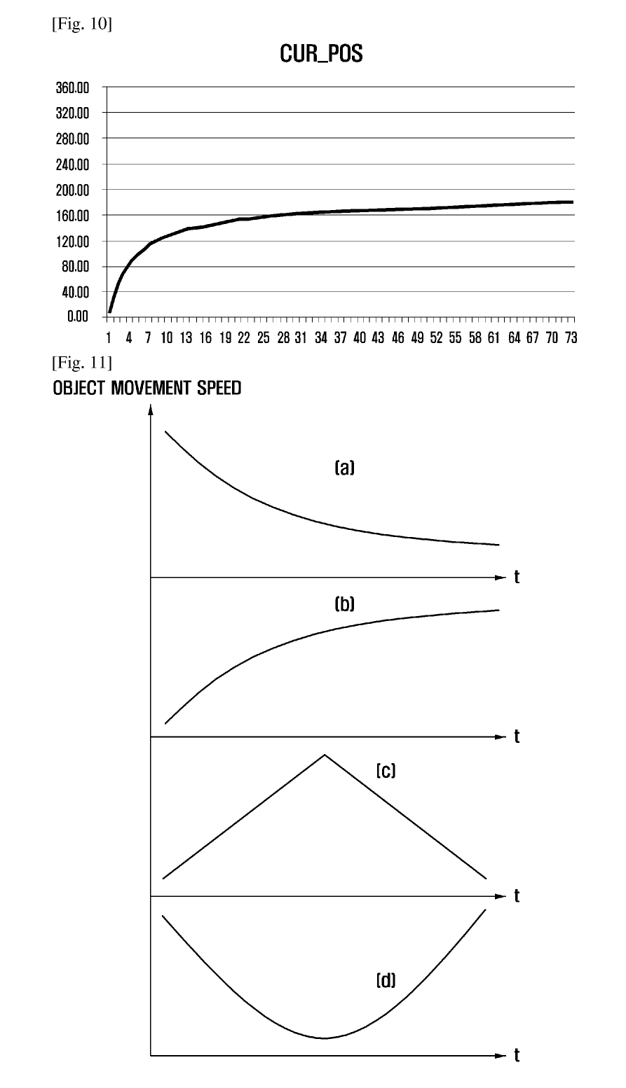

FIG. 10 is a graph illustrating variation of the current position of the object in unit of unit time.

The variation of the current position of the object has a relationship of inverse proportion to the object's movement speed per unit time. Referring to the graph of FIG. 10, it is shown that the movement speed decreases as the object is drawn near the target position.

FIG. 11 is a graph illustrating variation of movement speed of the object according to various embodiments of the present invention.

Parts (a) to (d) of FIG. 11 shows the variations of the movement speed of the object as the object is drawn near to the target position from the current position according to various embodiments of the present invention.

Part (a) of FIG. 11 shows an exemplary case where the movement speed decreases gradually as the object is drawn near to the target position, and part (b) of FIG. 11 shows an exemplary case where the movement speed increases gradually as the object is drawn near to the target position.

Part (c) of FIG. 11 shows an exemplary case where the movement speed increases gradually and then decreases gradually as the object is drawn near the target position, and part (d) of FIG. 11 shows an exemplary case where the movement speed decreases gradually and then increases gradually as the object is drawn near the target position.

The above descriptions on the various cases of movement speed variations of the object are just examples of the present invention but not limited thereto.

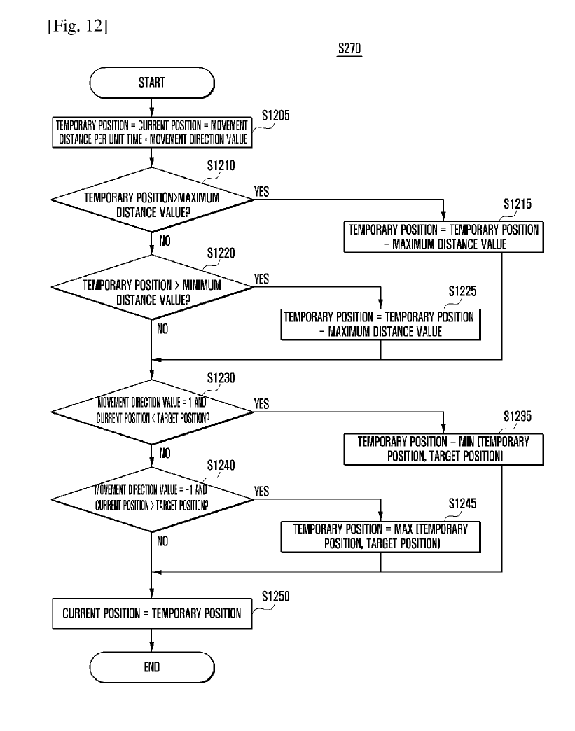

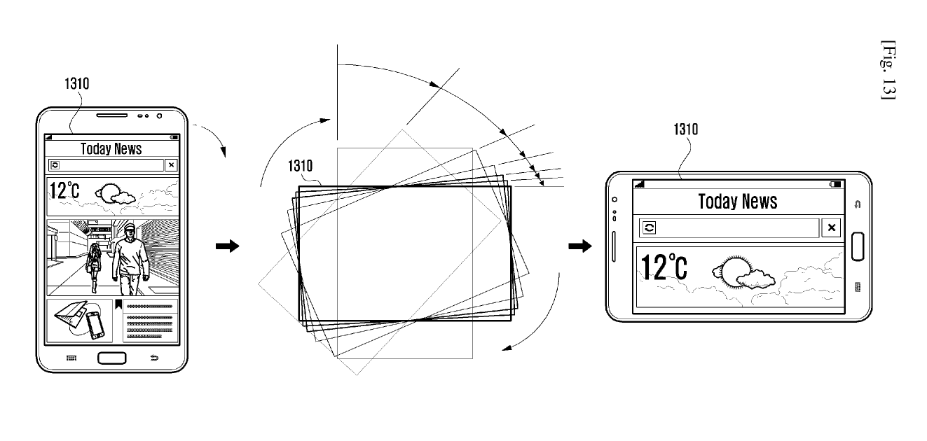

FIG. 12 is a flowchart illustrating the procedure of determining the current position of the object in the object movement method according to an embodiment of the present invention. FIG. 12 shows details of step S270 of FIG. 2.

The control unit 170 sets a temporary position of the object using equation (3) at step S1205.

Temporary position (TMP)=current position (CUR_POS)+movement distance per unit time (DELTA)*movement direction value (DIR) (3)

The control unit 170 determines whether the temporary position is greater than the maximum distance value at step S1210. If the temporary position is greater than the maximum distance value, this means that the position where the object is displayed is out of the display region of the display panel of the mobile terminal or the object rotates an angle equal to or greater than 360 degree. In this case, the control unit 170 updates the old temporary position to a new temporary position with the value obtained by subtracting the maximum distance value from the old temporary position.

Otherwise if the temporary position is not greater than the maximum distance value, the control unit 170 determines whether the temporary position is less than a minimum distance value at step S1220. If the temporary position is less than the minimum distance value, this means that that the position where the object is displayed is out of the display region of the display panel of the mobile terminal or the object rotates in the inverse direction. In this case, the control unit 170 updates the old temporary position to a new temporary position with the value obtained by adding the maximum distance value to the old temporary position.

The control unit determines whether the object's movement direction value is 1 (increment direction) and whether the target position is greater than the current position at step S1230. If the object's movement direction value is 1 and if the target position is greater than the current position, the control unit 170 sets the final temporary position to the minimum value between the temporary position and the target position at step 1235.

Otherwise, if the conditions of step 1230 are not fulfilled, the control unit 170 determines whether the object's movement direction value is −1 (decrement direction) and if the current position is greater than the target position at step S1240. If the object's movement direction value is set to −1 and if the current position is greater than the target position, the control unit 170 sets the final temporary position to the maximum value between the temporary position and the target position.

Otherwise, if the conditions of step S1240 are not fulfilled or after step S1235 of step S1245, the control unit 170 determines the current position to the temporary position (determined at previous step) at step S1250.

FIG. 13 is a diagram illustrating a procedure of rotating an image on the display panel along with the rotation of the mobile terminal in the object movement method according to an embodiment of the present invention.

FIG. 13 shows the mobile terminal positioned in the horizontal direction while display an image (object) according to the horizontal direction. If the mobile terminal rotates 90 degree in the clockwise direction, the sensing unit 160 of the mobile terminal detects the rotation angle of the mobile terminal by means of gyro sensor. Then the mobile terminal calculates the current and target positions and rotates the image as much as 90 degree from the current position to the target position.

In this case, the mobile terminal may set the image's rotation speed per unit time variable as shown in FIG. 13. It is noted that the only the image 1310 displayed on the display panel of the mobile terminal is depicted in FIG. 13, and it is assumed that the image's rotation speed per unit time decreases gradually. If the terminal rotates as much as 90 degree in the clockwise direction from the initial position, the image displayed on the display panel rotates as much as 90 degree in the clockwise direction.

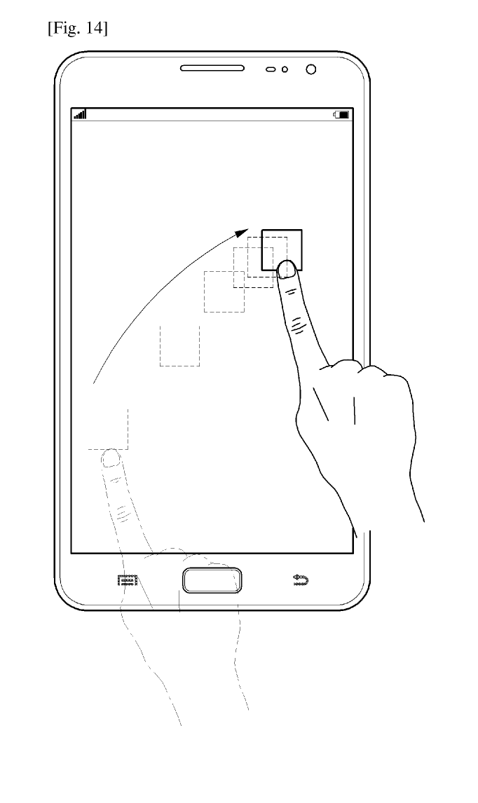

FIG. 14 is a diagram illustrating a procedure of moving an icon displayed on the display panel of the mobile terminal in response to a movement command target to the icon in the object movement method according to an embodiment of the present invention.

The mobile terminal may receive the icon movement command for moving the icon from the current position 1410 to the target position 1420. Then the mobile terminal may sets the icon's movement speed per the unit time variable as shown in FIG. 14. FIG. 14 is directed to the case where the icon's movement speed decreases gradually.

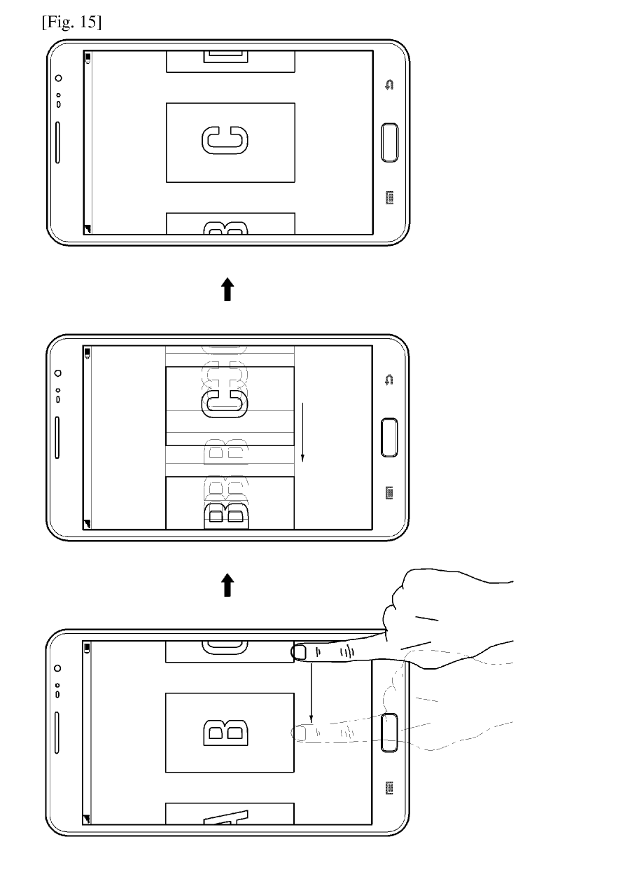

FIG. 15 is a diagram illustrating a procedure of switching from a currently displayed image to next image in response to a flip input in the object movement method according to an embodiment of the present invention.

FIG. 15 shows a state of displaying an image (object) in accordance with the orientation of the mobile terminal. If a flip command for navigating to the next image is received, the control unit 170 slides the screen to display the next image in the direction of the flip gesture. In this case, the mobile terminal may set the image switching speed per unit time variable. FIG. 15 is directed to the case where the image switching speed per unit time decreases gradually.

Although FIGS. 13 to 15 are directed to the case where the object's movement or rotation speed per unit time decreases, the present invention is not limited thereto. For example, it is possible to implement the present invention in such a way that the object's movement speed or rotation speed per unit time increases, or increases and then decreases or vice versa as shown in FIG. 11.

According to the present invention, if the object movement command is received, the mobile terminal sets the movement distance per unit time to a value variable as time advance such that the object is moved from the current position to the target position and then displayed at the target position. With this operation, the user is capable of experiencing smooth movement of the object. Since the movement distance per unit time is calculated at every drawn timing, if the target position changes in the state that the object is moving, the movement distance is recalculated in real time in response to the repeated user input.

The specification and drawings are to be regarded in an illustrative rather than a restrictive sense in order to help understand the present invention. It is obvious to those skilled in the art that various modifications and changes can be made thereto without departing from the broader spirit and scope of the invention.

1. An object movement method implemented in a terminal, the method comprising:
displaying an object;
receiving a movement command to move the object; and
moving the object from a current position to a target position at a speed varying according to a distance to the target position.

2. The method of claim 1, wherein moving comprises:
setting a movement direction and entire movement distance of the object based on the target and current positions;
setting a movement distance per unit time on the entire movement distance;
determining a movement position of the object on a display screen; and
moving the object to the movement position.

3. The method of claim 2, further comprising:
determining, after moving the object, whether the target position is changed;
initializing parameters necessary to determine the movement position;
determining the movement position of the object based on the initialized parameters; and
moving the object to the movement position.

4. The method of claim 2, further comprising:
determining, when the target position is not changed after displaying the object, a new movement position of the object at next time duration based on the movement position; and
displaying the object at the determined new movement position.

5. The method of claim 2, wherein setting a movement direction comprises:
determining a first temporary value according to a target size and a current position size;
determining a second temporary value according to a middle distance value size and a difference value between the target and current positions; and
determining a movement direction of the object based on a multiplication result of the first and second temporary values.

6. The method of claim 5, wherein determining a movement direction comprises determining the entire movement distance of the object based on a difference value between the target and current positions and a size of a value obtained by subtracting the difference value between the target and current positions from a maximum distance value.

7. The method of claim 2, wherein setting a movement distance per unit time comprises setting the movement distance per unit time to a value obtained by dividing the distance from the current position to the target position of the object with a divisor value.

8. The method of claim 7, wherein the divisor value comprises a sum of an initial divisor value and an incremental divisor value, and the incremental divisor value increases when the unit time elapses.

9. The method of claim 1, wherein the object comprises at least one of an image, a motion picture, a still picture, and an icon.

10. The method of claim 1, wherein the movement comprises at least one of rotation, position change, and switching.

11. A terminal comprising:
a display unit configured to display an object;
an input unit configured to receive a movement command to move the displayed object; and
a control unit configured to control, in receipt of the movement command, moving the object from a current position to a target position at a speed varying according to a distance to the target position.

12. The terminal of claim 11, wherein the control unit is configured to control:
(1) setting a movement direction and an entire movement distance of the object based on the target and current positions,
(2) setting a movement distance per unit time on the entire movement distance,
(3) determining a movement position of the object on the display screen, and
(4) moving the object to the movement position.

13. The terminal of claim 12, wherein the control unit is configured to control:
(1) determining, after moving the object, whether the target position is changed,
(2) initializing parameters necessary to determine the movement position,
(3) determining the movement position of the object based on the initialized parameters, and
(4) moving the object to the movement position.

14. The terminal of claim 12, wherein the control unit is configured to control determining, when the target position is not changed after displaying the object, a new movement position of the object at next time duration based on the movement position and displaying the object at the determined new movement position.

15. The terminal of claim 12, wherein the control unit is configured to control:
(1) determining a first temporary value according to a target size and a current position size;
(2) determining a second temporary value according to a middle distance value size and a difference value between the target and current positions; and
(3) determining a movement direction of the object based on a multiplication result of the first and second temporary values.

16. The terminal of claim 15, wherein the control unit is configured to determine the entire movement distance of the object based on a difference value between the target and current positions and a size of a value obtained by subtracting the difference value between the target and current positions from a maximum distance value.

17. The terminal of claim 12, wherein the control unit is configured to set the movement distance per unit time to a value obtained by dividing the distance from the current position to the target position of the object with a divisor value.

18. The terminal of claim 17, wherein the divisor value comprises a sum of an initial divisor value and an incremental divisor value, and wherein the incremental divisor value increases when the unit time elapses.

19. The terminal of claim 11, wherein the object comprises at least one of an image, a motion picture, a still picture, and an icon.

20. The terminal of claim 11, wherein the movement comprises at least one of rotation, position change, and switching.
